(19) United States
(12) Patent Application Publication
(10) Pub. No.: US 2022/0143554 A1
(43) Pub. Date: May 12, 2022

(54) IN SITU DETECTION SYSTEM AND METHOD OF DETECTING MEMBRANE WETTING

(71) Applicant: KING ABDULLAH UNIVERSITY OF SCIENCE AND TECHNOLOGY, Thuwal (SA)

(72) Inventors: Noreddine GHAFFOUR, Thuwal (SA); Alla ALPATOVA, Thuwal (SA); Adnan QAMAR, Thuwal (SA); Mohammed ALHADDAD, Thuwal (SA)

(21) Appl. No.: 17/428,421

(22) PCT Filed: Feb. 12, 2020
(86) PCT No.: PCT/IB2020/051138

§ 371 Date: Aug. 4, 2021

Related U.S. Application Data
(60) Provisional application No. 62/804,851, filed on Feb. 13, 2019.

(51) Int. Cl. B01D 61/36; B01D 65/10; C02F 1/44

(52) U.S. Cl. CPC B01D 61/368; B01D 61/364; B01D 61/366; B01D 65/10; C02F 2103/08; B01D 2313/143; B01D 2313/146; B01D 2313/345; C02F 1/447

(57) ABSTRACT

A membrane wettability system including a power source configured to generate a current; a measuring device configured to measure the current; a first conducting spacer that is electrically connected to one of the measuring device and the power source; and a second conducting spacer that is electrically connected to another one of the measuring device and the power source. The first conducting spacer is physically separated from the second conducting spacer by a membrane, which is not conducting the current.

### CROSS-REFERENCE TO RELATED APPLICATIONS

This application claims priority to U.S. Provisional Patent Application No. 62/804,851, filed on Feb. 13, 2019, entitled “IN SITU DETECTION OF MEMBRANE WETTING BY ELECTRICALLY CONDUCTIVE SPACERS,” the disclosure of which is incorporated herein by reference in its entirety.

### BACKGROUND

### TECHNICAL FIELD

Embodiments of the subject matter disclosed herein generally relate to a system and method for detecting membrane wetting, and more particularly, to an in situ detection system for detecting when a membrane in a membrane distillation system loses its distillation characteristics.

### DISCUSSION OF THE BACKGROUND

The shortage of freshwater supply and deprivation of the oil resources across the globe augment the development of new cost-effective desalination technologies. Membrane distillation (MD), which combines membrane separation and thermal processes, is viewed as an efficient tool in water desalination due to its ability to produce high-quality permeate water while maintaining stable permeate fluxes. A typical membrane distillation system 100 is illustrated in FIG. 1, and it includes a membrane distillation unit 110 that is fluidly connected to a feed reservoir 130 and a permeate reservoir 140. The feed reservoir 130 holds the feed 132 (e.g., seawater or any solution which has electrolytes), which is pumped with a pump 134 into a feed chamber 114 of the distillation unit 110. The feed 132 may be heated with a heater 136 prior to being supplied to the feed part 114. The permeate reservoir 140 holds the coolant water 142 (e.g., fresh water), which is circulated to the permeate part 116 of the distillation unit 110. A membrane 112 is placed between the feed part 114 and the permeate part 116, so that the fluid feed 132 cannot pass into the permeate part 116 and the coolant water 142 cannot pass into feed part 114. The membrane 112 is so selected that only water vapors from the feed 114 pass into the permeate part 116. The coolant water 142 is pumped with a pump 144 back to the permeate container 140. A chiller 146 may be placed next to the pipe that collects the permeate 148 to cool down the permeate after leaving the permeate part 116.

For this technology, the water vapor 138, which is generated upon heating the feed stream 132, passes through the hydrophobic microporous membrane 112 and condenses in the permeate part 116 using the incoming permeate 142 as a coolant. Due to its hydrophobic properties, the membrane 112 acts as a physical barrier which prevents the feed water from entering its pores. As such, the condensed water 148, which resulted from the condensation of the water vapor 138, is characterized by low conductivity and is virtually free of organic and inorganic contaminants.

Membrane wetting is a common drawback of the MD technology. The membrane wetting impends the wide application of the MD technology in water treatment and desalination technologies. The wetting is caused by direct permeation of the membrane pores by the salty water from the feed 132, when the pressure between the permeate part 116 and the feed part 114, inside the MD module 110, exceeds the liquid entry pressure (LEP) of a single pore. The liquid entry pressure is defined as the pressure necessary to force the fluid water (not the vapor water) through the membrane pores.

The MD membranes are predominantly comprised of highly hydrophobic materials with a low value of the surface energy. The MD membranes may include polypropylene (PP), polytetrafluoroethylene (PTFE), polyvinylidene fluoride (PVDF) or any other hydrophobic material. As the MD distillation process evolves and the LEP is exceeded, amphiphilic molecules (e.g., surfactants) or low-surface tension liquids (e.g., alcohols) induced pore wetting of the membrane 112. When membrane 112 become wetted, the feed water 132 could penetrate the pores and enter the permeate part 116, thus contaminating the permeate 142.

Capillary condensation, scale deposition, organic fouling and changes in the process operating parameters have also been reported to induce membrane wetting. As a result, the vapor flux 138 across the membrane 112 is altered and the quality of the condensed water 148 deteriorates. Therefore, to prevent process failure and avoid permeate quality decline, membrane wetting needs to be detected in its early stage.

Currently, membrane wetting is detected based on changes in the salts rejection over the process time. In this approach, the conductivity of the condensed water 148 is monitored at a monitoring device 150, which is fluidly connected to the permeate pipe. When the monitoring device detects an increase in the conductivity of the permeate with the process time, the monitoring device uses this increase as a wetting indicator. Despite its apparent simplicity, the conductivity monitoring method has some intrinsic disadvantages. For example, if the MD module 110 includes plural cells, which is typical the case, the permeate from all these cells is mixed and the mixed permeate is tested by the monitoring device 150. Thus, it can be difficult to apply this process in a full scale plant with multiple MD modules stacked as it is not possible to identify which module is failing. Moreover, due to the existing time lag between when the conductivity of the permeate is increasing and the actual time when the pore is wet, the pore wetting will continuously propagate until any significant change in the condensate water quality is detected.

A combined electrochemical and membrane separation approach for membrane fouling monitoring has been recently proposed by several authors. This approach is based on the application of electrochemical impedance spectroscopy to study the dynamic and mechanisms of pore wetting. An electrically conductive composite membrane in which a carbon support layer acts as a working electrode to electrolytically detect pore wetting has been disclosed in [1]. However, the use of custom-made membranes in MD practice is quite complicated as these membranes are not commercially available.

Thus, there is a need for a simple and efficient method and system for detecting membrane fouling.

### BRIEF SUMMARY OF THE INVENTION

According to an embodiment, there is a membrane wettability system that includes a power source configured to generate a current; a measuring device configured to measure the current; a first conducting spacer that is electrically connected to one of the measuring device and the power source; and a second conducting spacer that is electrically connected to another one of the measuring device and the power source. The first conducting spacer is physically separated from the second conducting spacer by a membrane, which is not conducting the current.

According to another embodiment, there is a membrane distillation system that includes a membrane distillation cell configured to separate a permeate from a feed with a membrane, a feed container that supplies the feed to the membrane distillation cell, a permeate container that collects the permeate from the membrane distillation cell, and a wettability membrane detecting system configured to determine when the membrane experience a wettability condition. The wettability membrane detecting system includes a power source configured to generate a current, a measuring device configured to measure the current, a first conducting spacer that is electrically connected to one of the measuring device and the power source, and a second conducting spacer that is electrically connected to another one of the measuring device and the power source. The first conducting spacer is physically separated from the second conducting spacer by the membrane, which is not conducting the current.

According to yet another embodiment, there is a method for determining a wetting membrane pore condition. The method includes sandwiching a membrane between first and second conducting spacers, electrically connecting the first conducting spacer to one of a measuring device and a power source, electrically connecting the second conducting spacer to another one of the measuring device and the power source, generating a current with the power source, measuring the current with the measuring device, and determining that the membrane is experiencing the wetting membrane condition when the measured current is larger than a given threshold. The membrane is not conducting the current.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a membrane distillation system;

FIG. 2 is a schematic diagram that illustrates a spacer used with a membrane in a membrane distillation system;

FIG. 3 is a schematic diagram of a spacer coated with a conductive layer to become electrically conductive;

FIG. 4 illustrates a membrane distillation cell having a membrane sandwiched between two conductive spacers;

FIGS. 5A to 5D illustrate a membrane wetting determination system and its working principle;

FIG. 6 illustrates a distillation system that uses a membrane wetting determination system;

FIG. 7 illustrates the response of the membrane wetting determination system under various concentrations of the feed;

FIG. 8 illustrates the response of the membrane wetting determination system when its operating voltage is increased; and

FIG. 9 is a flowchart of a method for separating a permeate from a feed by using a membrane wetting determination system.

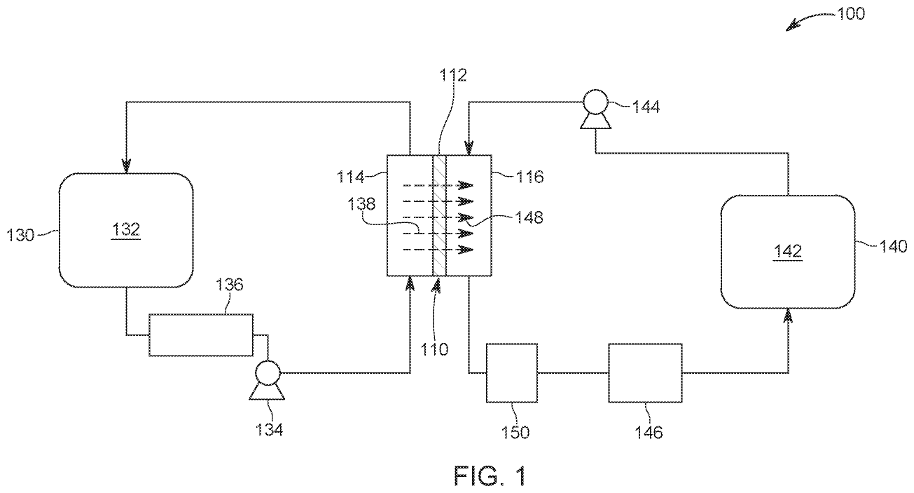

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a single membrane unit. However, the embodiments to be discussed next are not limited to one membrane unit, but may be applied to plural membrane units or to other units that use a membrane that may experience membrane wetting.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel system for detection of membrane wetting is discussed. Such system is desired for maintaining a stable performance of MD operations. The novel system targets the issue of membrane integrity and allows for the early detection of membrane wetting as soon as it appears so that the MD system failures can be minimized. The detection system is implemented at the spacer level. The use of spacers is also expected to maximize permeate production and enhance the biofouling control thereby improving the overall process performance. The novel system can be implemented for any spacer design and geometry including commercial spacers and newly designed spacers. Thus, an existing MD system that uses old spacers can be retrofitted with the novel detection system. The spacer may be made of a polymeric material that is covered with an electrically conducting layer or the spacer may be entirely made of a conducting material. An advantage of the proposed technology is its simplicity and good scalability because it can be implemented by modifying the existing systems.

In one embodiment, the detection system is expected to achieve continuous, real-time, monitoring of the electrical current during the MD operations, which result in the immediate in situ wetting detection so that the fouling control measures can be applied in a well-timed manner. For example, once an increase in the electrical current is detected by the detection system, the cleaning-in-place (CIP) can be initiated to deter wetting by removing the wetting-causing foulants from the membrane surface. This will minimize membrane damage and enable stable MD operation while producing high quality permeate water.

The application of the wettability detection system will make the MD process more versatile with a potential expansion to a level where it can be applied to not only drinking water production, but also to non-portable water treatment applications, including irrigation. The suggested technology is viewed as an innovation that could promote commercialization of the MD process from seawater desalination to a wider range of potential practices (municipal wastewater treatment, reclamation of produced water, food industry, etc.). Furthermore, this technology can be applied in any process in which the surface/bulk material wetting is an issue and a dielectric fluid is present in contact with such material.

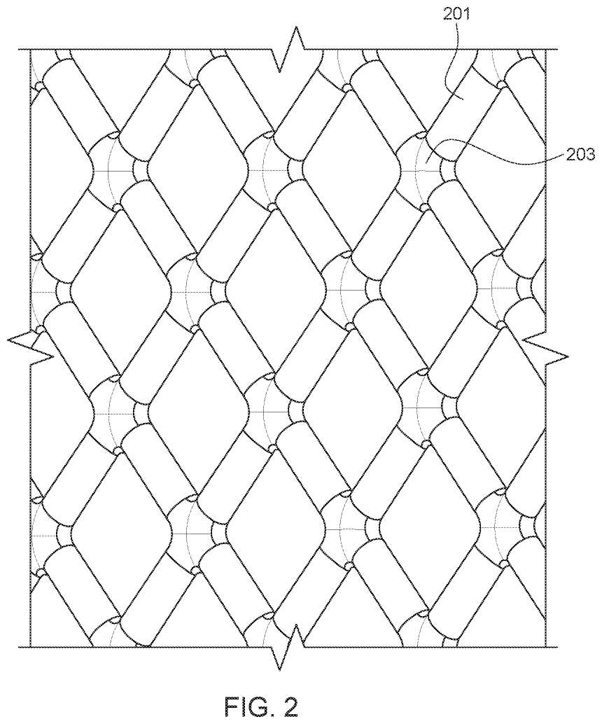

Polymeric spacers (i.e., non-conductive spacers) are commonly used in membrane separation to promote turbulence/flow unsteadiness at the membrane surface, which can significantly mitigate fouling-associated issues in the vicinity of the membrane surface [2, 3]. FIG. 2 shows a spacer 200 formed from a polymer as plural tubes 201 that intersect at points 203 with each other at a given angle (called strand angle). Any commercial spacer or any nee spacer design with mesh type structure can be deployed.

There is also evidence that the application of spacers in the MD process reduces the temperature polarization and improves the heat transfer coefficient. As a result, the vapor flux across the membrane is enhanced. Furthermore, electrically conductive spacers have been recently probed for the biofouling control in reverse osmosis [4]. With the current advances in membrane separation technology, polymeric spacers are now available in various designs and arrangements so their wide implementation in MD processes is easily achieved.

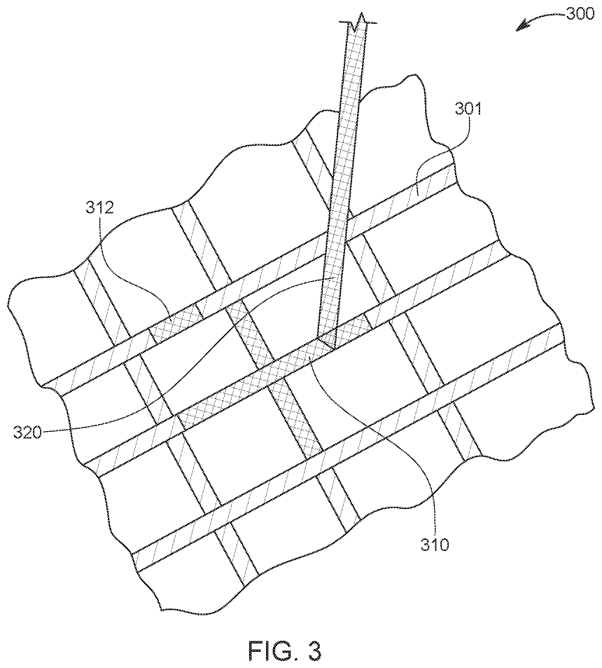

According to the embodiment illustrated in FIG. 3, a polymeric spacer 300 is coated with a conductive material layer 310 to achieve electrical conductivity. FIG. 3 shows the conductive material layer 310 only partially covering the pipes 301 that make up the spacer 300. However, the conductive material layer 310 can be extended to cover the entire spacer. In one application, only selected parts of the spacer are covered with the conductive layer. For example, it is possible to coat only the top part of the spacer. In another application, it is possible to coat only a given segment 312 of a given pipe 301, as also shown in FIG. 3. Then, an electrode 320 is attached to one or more or the entire conductive layer 310. For the existing MD systems, the existing spacers can be coated with the conductor layer 310 and then be reused. The coating material can include any conductive material (e.g., platinum, gold, carbon, etc.). While the spacer 300 is defined by its thickness, filament shape and size, strand angle, mesh size or any other design parameter, the coating layer is defined by its thickness and the amount of surface of the spacer that is covered.

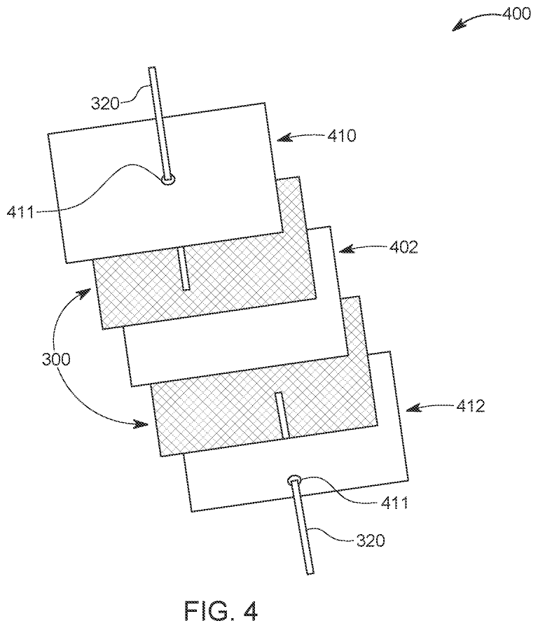

The spacer 300 shown in FIG. 3 is added on both sides of the membrane 402, as shown in FIG. 4. In one application, the spacers are in direct contact with membrane. Note that the membrane 402 is made of a material that is not an electrical conductor. FIG. 4 shows the membrane distillation (DCMD) cell 400 that includes, in addition to the spacers 300 and the membrane 402, top and bottom cell walls 410 and 412, respectively. Holes 411 are formed into the top and bottom cell walls 410 and 412 for allowing the electrodes 320, illustrated in FIG. 3, to enter inside the cell 400 and electrically contact each spacer 300. Because the membrane 402 is not an electrical conductor, an electrical current cannot take place across the membrane 402. However, if ions from the feed pass through the pores of the membrane 402 to the permeate, then an electrical current can be established between the two spacers 300 that sandwich the membrane 402. This mechanism is now discussed in more detail.

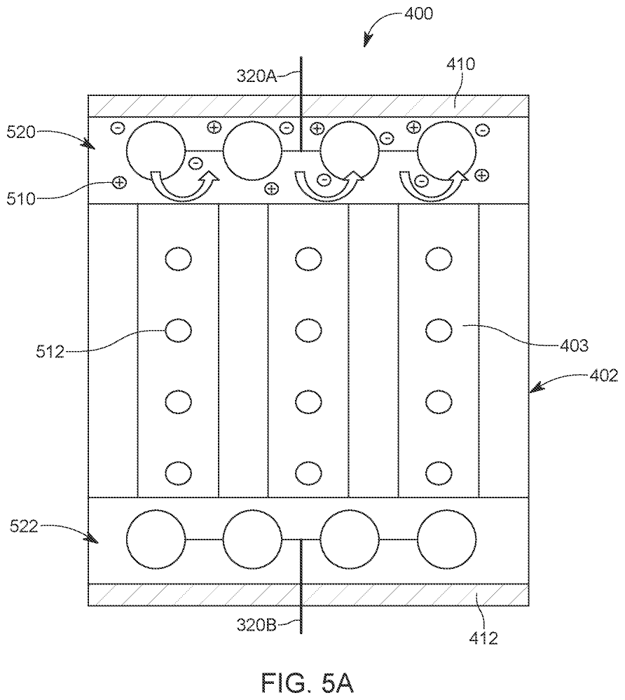

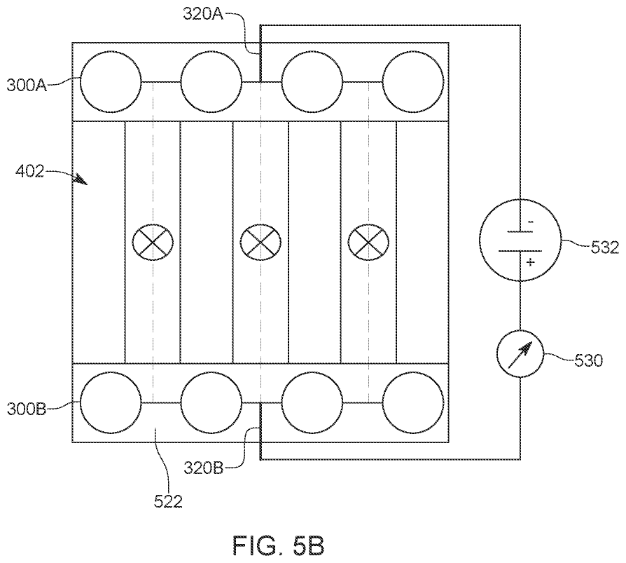

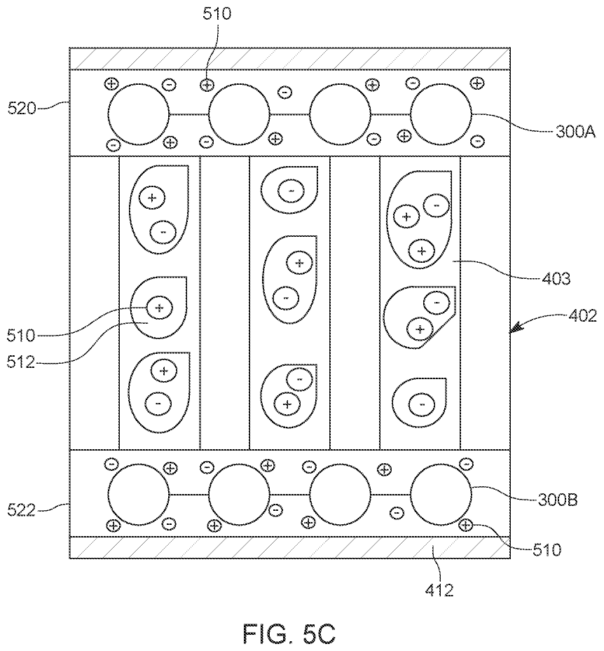

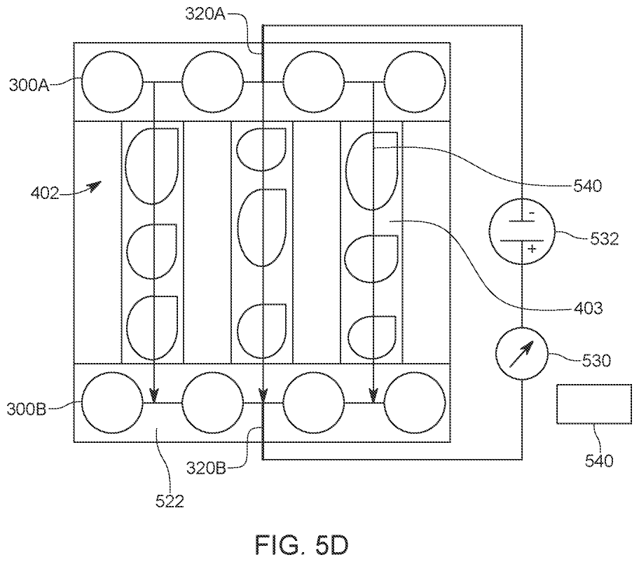

The DCMD cell 400 is further illustrated in FIGS. 5A to 5D when fully functional and when experiencing membrane wetting. FIG. 5A shows the cell 400 having various ions 510 present in the feed 520. The feed is directed between the membrane 402 and the upper wall 410 of the cell 400. FIG. 5A also shows that no ions are present in the permeate 522, meaning that only water vapors 512 are passing through the pores 403 in the membrane 402. This show that the membrane 402 is healthy, i.e., there is no membrane wetting. The feed 520 and the permeate 530 are supplied by corresponding pumps, from their corresponding vessels. FIG. 5A also shows the top spacer 300A and the bottom spacer 300B directly sandwiching the membrane 402. Top electrode 320A and bottom electrode 320B, that electrically connect to the bottom and top spacers 300A and 300B, respectively, are also shown.

An electrical circuit corresponding to the cell 400 in FIG. 5A is shown in FIG. 5B. The top and bottom cell walls and the ions are omitted in this figure for simplicity. A measuring device 530, for example, voltmeter, amperemeter, amplifier, digital multimeter, a combination of these devices or any other device that can measure a current or voltage or resistance or equivalent electrical parameter is connected between the electrodes 320A and 320B together with a direct current power source 532. If no ions 510 are penetrating through the membrane and entering the pores 402, then the measuring device 530 detects only a small electrical conductivity. The electrodes 320A and 320B may be formed of platinum (or any metal which do not participate in oxidation/reduction reaction, like noble metals, graphite, etc.), for electrical conduction.

However, if the ions 510 are entering together with the steam 512 through the pores 403 as shown in FIG. 5C, then the measuring device 530 would determine an increased electrical conductivity due to the presence of the current 540 through the pores of the membrane. Note that the current 540, which is illustrated in FIG. 5D, essentially closes the electrical circuit formed by the spacers, their electrodes, and the measuring circuit. This electrical circuit is open in FIG. 5B, when the membrane is not wet, because there are no ions 510 passing the channels 403 of the membrane 402.

Thus, by having the electrical conducting spacers 300A and 300B sandwiching the membrane 402, and electrodes from these spacers being connected to the measuring device 530, allow the operator of the cell 400 to determine as soon as the membrane becomes wet, i.e., ions are passing through the channels of the membrane. By setting a certain threshold at the measuring device 530, or at a processor 540 that is connected to the measuring device 530, it is possible to automatically generate an alarm for the operator when the measured electrical conductivity across the membrane 402 is above a certain limit, which is identified to correspond to membrane wetting.

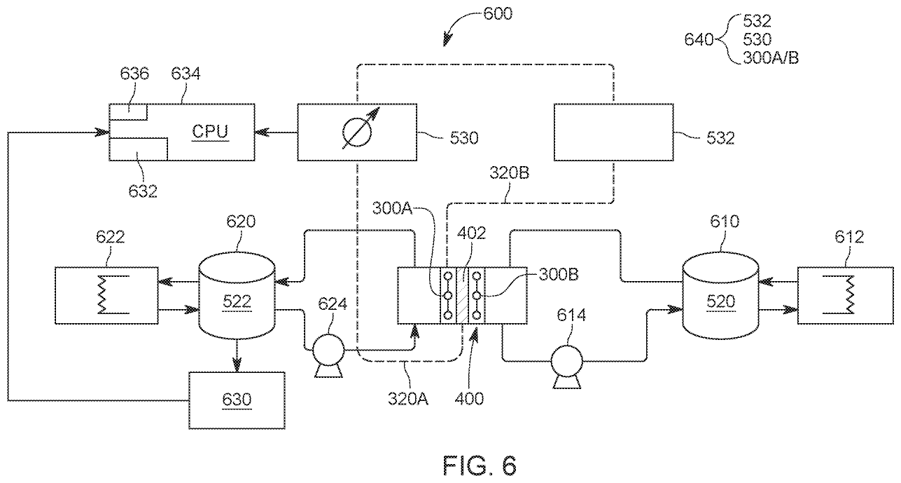

In one application, the DCMD cell 400 discussed above is implemented in an actual MD system 600 as illustrated in FIG. 6. FIG. 6 shows the DCMD cell 400 fluidly connected to the feed container 610, which stores the feed 520. A heater 612 (electrical or any other type of heater) may be used to maintain the feed 520 at a constant temperature. A pump 614 is used to maintain a certain flow speed of the feed 520. The DCMD cell 400 is also fluidly connected to the permeate container 620, which stores the permeate 522. The permeate 522 may be cooled with a cooling device 622, for example, an electrical chiller. Note that although the heater 612 and the cooling device 622 are shown as being connected in parallel to their respective tanks, they can also be mounted in series. A pump 624 is used to maintain a flow of the permeate 522 at a desired speed. The amount of the produced permeate 522 may be estimated with a balance 630, and the data transmitted to a data acquisition system 632, which is part of a processor 634. The electrical circuit formed by the electrodes 320A and 320B of the cell 400 is connected to the power source 532 and the measuring device 530 (or vice versa, i.e., connecting with an opposite polarity, the current detection circuit will remain the same in both cases), for measuring the electrical conductivity across the membrane 402. The source 532, the measuring device 530, and the electrically conductive spacers 300 form the membrane wettability detection system 640.

Thus, in one application, the membrane wettability system 640 includes the power source 532, which is configured to generate a current, the measuring device 530, which is configured to measure the current, with first conducting spacer 300A which is electrically connected to the measuring device 530, and the second conducting spacer 300B, which is electrically connected to the power source 532 (or vice versa, i.e. connecting with opposite polarity, the current detection circuit will remain the same in both cases). The first conducting spacer 300A is physically separated from the second conducting spacer 300B by the membrane 402, which is not conducting the current.

In one application, the first and second conducting spacers are in direct contact to the membrane. The first and second conducting spacers are made of a non-conducting polymer that is coated with an electrical conducting layer. While it is possible that the electrical conducting layer fully covers the first and second conducting spacers, it is also possible that the electrical conducting layer partially covers the first and second conducting spacers.

Processor 634 may also include a transceiver for communicating with any part of the system 600, but also for being able to transmit an alarm to the operator of the system when the electrical conductivity of the membrane 402 increases over a given limit. Although system 600 is shown in FIG. 6 as having a single DCMD cell 400, a plural cells may be implemented. According to an embodiment, each cell has the configuration shown in FIG. 4 and electrodes from each cell may be electrically connected to the source 532 and measuring device 530 for measuring the electrical conductivity. The processor 634 may implement any known communication protocol for handling the communication with the plural cells so that the electrical conductivity of each cell is received and compared with its own threshold.

There also exists a configuration called “permeate (or “water”) gap membrane distillation” in which the vapor is condensed and accumulated on the other side of membrane and then exits the chamber. In this case, the membrane module is divided into three chambers, the hot chamber is the same as in the DCMD, the middle chamber is filled with the condensed water and separated from the hot chamber by the membrane and by a stainless steel plate from the cold chamber. The coolant water circulates in the cold chamber just like in the DCMD system. The water vapor which passes through the pores of the membrane gets inside the middle chamber, contacts the cold plate and condenses, and then accumulates and fills the middle chamber. When the chamber is full, the condensed water exists it and gets collected. The difference between these two types of MD modules is that in the direct contact system, the vapor condenses into the coolant water stream and in this system the permeate is pure condensate. The principle of wetting detection in both systems would be the same, just in latter system spacer and one of the electrodes will be inserted into the middle chamber. The features discussed above with regard to the system 600 are also applicable to this system. In fact, the features discussed with regard to system 600 are applicable to any MD system.

Further, a membrane distillation system is understood in this application to mean not only a system that separates fresh water from saltwater by membrane distillation, but also systems that perform similar processes, e.g., gas separation, pervaporation or pervaporative separation, which is a processing method for the separation of mixtures of liquids by partial vaporization through a non-porous or porous membrane.

To test the membrane wettability of the membrane of the cell 400 discussed above, the inventors have conducted a couple of experiments at the lab scale using custom-made DCMD cells which utilized a 2 cm×10 cm hydrophobic flat-sheet PTFE membrane. The DCMD process was operated with the feed and cold streams flowing in the counter-current direction. The temperatures of the hot feed and cold permeate streams were maintained at 70° C. and 20° C. by using the electrical heater 612 and chiller 622, respectively. The flow rates of both streams were set at 500 mL/min, and were maintained with the pumps 614 and 624. The polymeric spacers 300A and 300B were 3D printed by using acrylic powder and they were coated with platinum having a thickness of 600 nm. A cathodic voltage in a range of 1-2 V was applied by the power source 532 at the permeate side of the membrane.

Four different DCMD experiments were conducted by using the following feed and coolant solutions:

(1) Ultrapure water (resistance of 0.1 MΩ·cm at 25° C. and conductivity of 10 μS/cm) at both the feed and coolant sides (called herein the control 1 experiment).

(2) 15 g/L of sodium chloride (NaCl) electrolyte solution at both the feed and coolant sides (called herein the control 2 experiment).

(3) 15 g/L NaCl electrolyte solution and ultrapure water at the feed and coolant sides, respectively (called herein the normal DCMD experiment).

(4) After completion of the experiment (3), the membrane was wetted with ethyl alcohol (C₂H₅OH) and the DCMD process was resumed (called herein the DCMD experiment with wetted membrane).

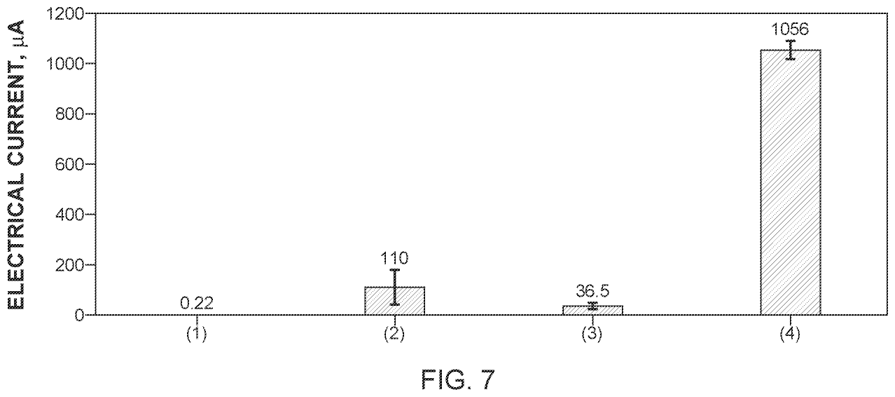

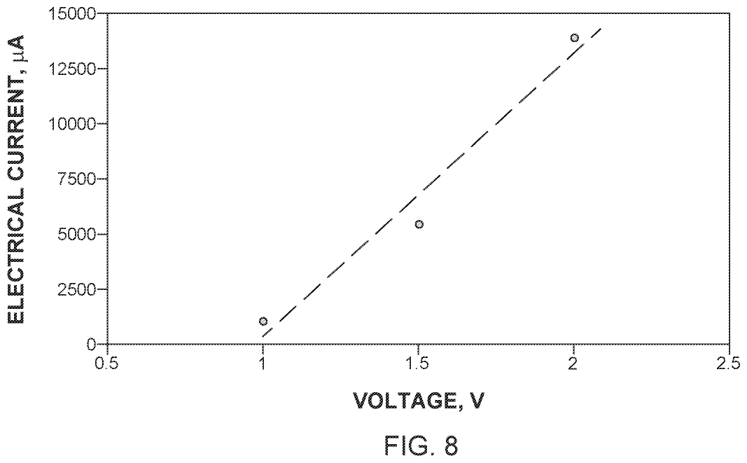

The purpose of the control and normal DCMD experiments was to probe the electrical current (electrical conductivity) in the system under conditions in which the membrane pores are not wetted. The obtained trends were then compared to the results achieved in the experiment (4), when the pore wetting was induced by the addition of the ethyl alcohol. As illustrated in FIG. 7, which shows the changes in the magnitude of electrical current with respect to the different DCMD experiments (1) to (4), a significant increase in the intensity of electrical current was observed when the membrane was subjected to wetting (experiment (4)) as compared to the experiments (1) to (3) when the membrane integrity was not compromised. In this regard, note that the experiment (4) shows a current of 1056±42 μA, experiment (1) shows a current of 0.22±0.17 μA, experiment (2) shows a current of 110±71 μA, and experiment (3) show a current of 36.5±6.4 μA. The observed effect demonstrates that the proposed technology is capable of detecting the increase in the electrical current due to passage of Na⁺ and Cl⁻ ions 510, from the feed 520 to the permeate 522 side of the membrane, i.e., the condition in which the membrane integrity was compromised. Moreover, when the applied voltage of the power source 532 was further increased, from 1 V to 2 V, the magnitude of the electrical current generated in the system followed a linear trend (R²=0.97) and increased from 1,104 μA to 13,991 μA, as illustrated in FIG. 8.

The early detection of membrane wetting is desired in maintaining a stable performance of MD operations in real world distillation plants. The novel cell 400 that has a membrane wettability detection system targets the fundamental issue of membrane integrity and allows for the early detection of membrane wetting, as soon as it appears so that the MD system's failures can be minimized. The use of electrically conductive spacers is also expected to maximize permeate production and enhance the biofouling control thereby improving the overall process performance; it is also applicable for any spacer design including commercial spacers and newly designed spacers. The novel cell has an advantage that can be scaled and retroactively implemented in the existing plants.

It is expected that continuous real-time monitoring of the electrical current during the MD operations will result in the immediate in situ wetting detection so that the fouling control measures can be applied in a well-timed manner. For example, once an increase in the electrical current 540 is detected, the CIP can be initiated to deter wetting by removing the wetting-causing foulants from the membrane surface. This will minimize membrane damage and enable stable MD operation while producing high quality permeate water. Furthermore, this technology can be applied in any process in which surface/bulk material wetting is an issue and dielectric fluid is present in contact with such material.

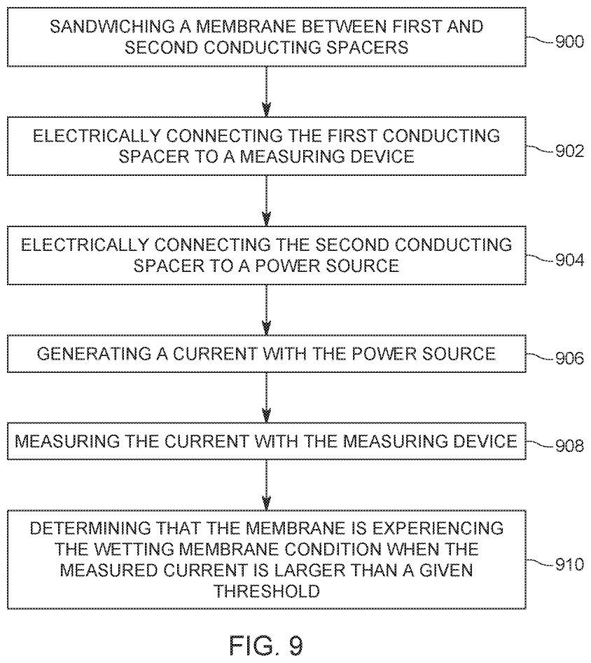

A method for determining a wetting membrane condition, which is illustrated in FIG. 9, includes a step 900 of sandwiching a membrane between first and second conducting spacers, a step 902 of electrically connecting the first conducting spacer to a measuring device, a step 904 of electrically connecting the second conducting spacer to a power source (or vice versa, i.e., connecting with an opposite polarity, the current detection circuit will remain the same in both cases), a step 906 of generating a current with the power source, a step 908 of measuring the current with the measuring device, and a step 910 of determining that the membrane is experiencing the wetting membrane condition when the measured current is larger than a given threshold, where the membrane pore is not conducting the liquid. In one application, the method further includes a step of sending an alarm when the current is larger than the given threshold.

The disclosed embodiments provide a membrane wettability detection system for detecting when a membrane loses its distillation properties. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

Ahmed, F. E., B. S. Lalia, and R. Hashaikeh, Membrane-based detection of wetting phenomenon in direct contact membrane distillation. Journal of Membrane Science, 2017. 535: p. 89-93.

Mo, H. and H. Y. Ng, An experimental study on the effect of spacer on concentration polarization in a long channel reverse osmosis membrane cell. Water Science and Technology, 2010. 61(8): p. 2035-2041.

Bucs, S. S., et al., Effect of different commercial feed spacers on biofouling of reverse osmosis membrane systems: A numerical study. Desalination, 2014. 343: p. 26-37.

Baek, Y., et al., Electroconductive Feed Spacer as a Tool for Biofouling Control in a Membrane System for Water Treatment. Environmental Science & Technology Letters, 2014. 1(2): p. 179-184.

1. A membrane wettability system comprising:
a power source configured to generate a current;
a measuring device configured to measure the current;
a first conducting spacer that is electrically connected to one of the measuring device and the power source; and
a second conducting spacer that is electrically connected to another one of the measuring device and the power source,
wherein the first conducting spacer is physically separated from the second conducting spacer by a membrane which is not conducting the current.

2. The system of claim 1, wherein the first and second conducting spacers are in direct contact to the membrane.

3. The system of claim 1, wherein the first and second conducting spacers are either made of a non-conducting polymer that is coated with an electrical conducting layer, or they are made entirely of a conducting material.

4. The system of claim 3, wherein the electrical conducting layer fully covers the first and second conducting spacers.

5. The system of claim 3, wherein the electrical conducting layer partially covers the first and second conducting spacers.

6. The system of claim 3, wherein the first and second conducting spacers are shaped as tubes connected to each other.

7. The system of claim 1, wherein the power source is a direct current power source and the measuring device is a multimeter.

8. The system of claim 1, further comprising:
first and second metal electrodes directly connected to the first and second conducting spacers, respectively, the first metal electrode being connected to the power source and the second metal electrode being connected to the measuring device,
wherein the first and second electrodes are selected to not participate in an oxidation or reduction reaction.

9. The system of claim 1, further comprising:
a processor configured to calculate an electrical current passing from the first conducting spacer to the second conducting spacer, and also configured to generate an alarm when the electrical current is larger than a given threshold,
wherein the alarm is associated with membrane wetting.

10. A membrane distillation system comprising:
a membrane distillation cell configured to separate a permeate from a feed with a membrane;
a feed container that supplies the feed to the membrane distillation cell;
a permeate container that collects the permeate from the membrane distillation cell; and
a wettability membrane detecting system configured to determine when the membrane experience a wettability condition,
wherein the wettability membrane detecting system comprises:
a power source configured to generate a current,
a measuring device configured to measure the current,
a first conducting spacer that is electrically connected to one of the measuring device and the power source, and
a second conducting spacer that is electrically connected to another one of the measuring device and the power source,
wherein the first conducting spacer is physically separated from the second conducting spacer by the membrane which is not conducting the current.

11. The system of claim 10, wherein the first and second conducting spacers are in direct contact with the membrane.

12. The system of claim 10, wherein the first and second conducting spacers are made of a non-conducting polymer that is coated with an electrical conducting layer.

13. The system of claim 12, wherein the first and second conducting spacers are shaped as tubes connected to each other.

14. The system of claim 10, wherein the power source is a direct current power source and the measuring device is a multimeter.

15. The system of claim 10, further comprising:
first and second metal electrodes directly connected to the first and second conducting spacers, respectively, the first metal electrode being connected to the power source and the second metal electrode being connected to the measuring device,
wherein the first and second electrodes are selected to not participate in an oxidation or reduction reaction.

16. The system of claim 10, further comprising:
a processor configured to calculate an electrical current passing from the first conducting spacer to the second conducting spacer, and also configured to generate an alarm when the electrical current is larger than a given threshold,
wherein the alarm is associated with the wettability condition.

17. A method for determining a wetting membrane pore condition, the method comprising:
sandwiching a membrane between first and second conducting spacers;
electrically connecting the first conducting spacer to one of a measuring device and a power source;
electrically connecting the second conducting spacer to another one of the measuring device and the power source;
generating a current with the power source;
measuring the current with the measuring device; and
determining that the membrane is experiencing the wetting membrane condition when the measured current is larger than a given threshold,
wherein the membrane is not conducting the current.

18. The method of claim 17, further comprising:
sending an alarm when the current is larger than the given threshold.
